(19) United States
(12) Patent Application Publication
(10) Pub. No.: US 2025/0239180 A1
(43) Pub. Date: Jul. 24, 2025

(54) PELVIC WOUNDS FOR PATIENT SIMULATORS

(71) Applicant: GAUMARD SCIENTIFIC COMPANY, INC., Miami, FL (US)

(72) Inventors: Karina ZORNOZA, Miami, FL (US); Arian HERNANDEZ, Miami, FL (US)

(21) Appl. No.: 19/029,872

(22) Filed: Jan. 17, 2025

Related U.S. Application Data
(60) Provisional application No. 63/623,086, filed on Jan. 19, 2024.

(51) Int. Cl. G09B 23/30

(52) U.S. Cl. CPC G09B 23/303

(57) ABSTRACT

Simulated wounds for patient simulators and associated devices, systems, and methods are provided. In some instances, a patient simulator comprises a simulated torso having a recess; and a wound assembly positioned within the recess of the simulated torso. The wound assembly comprises a multi-layered tissue structure with a central cavity in communication with a reservoir of simulated blood. A control unit associated with the wound assembly is configured to control an amount of simulated blood flow through the wound assembly based on at least one of an application of packing material into the central cavity or application of pressure to the wound assembly.

### CROSS-REFERENCE TO RELATED APPLICATIONS

The present application claims priority to and the benefit of U.S. Provisional Patent Application No. 63/623,086, filed Jan. 19, 2024, which is hereby incorporated by reference in its entirety for all applicable purposes.

### INTRODUCTION

The present disclosure relates generally to patient simulators. While it is desirable to train medical personnel in patient care protocols before allowing contact with real patients, textbooks and flash cards lack the important benefits to students that can be attained from hands-on practice. On the other hand, allowing inexperienced students to perform medical procedures on actual patients that would allow for the hands-on practice cannot be considered a viable alternative because of the inherent risk to the patient. Because of these factors patient care education has often been taught using medical instruments to perform patient care activity on a simulator, such as a manikin. Examples of such simulators include those disclosed in U.S. Pat. Nos. 11,756,451, 8,696,362, 8,016,598, 7,976,312, 7,976,313, U.S. patent application Ser. No. 11/952,669 (Publication No. 20090148822), U.S. Pat. Nos. 7,114,954, 6,758,676, 6,503,087, 6,527,558, 6,443,735, 6,193,519, and 5,853,292, each herein incorporated by reference in its entirety.

While these simulators have been adequate in many respects, they have not been adequate in all respects. Therefore, what is needed is an interactive education system for use in conducting patient care training sessions that is even more realistic and/or includes additional simulated features.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

This disclosure describes pelvic wounds for patient simulators. In this regard, the pelvic wounds of the current disclosure can include a multi-layered silicone and foam insert with a hydraulic port bushing used to simulate a severe arterial/venous bleed as a consequence of a gunshot wound or other similar injury. The pelvic wounds of the present disclosure are suitable for use a simulated junction wound that is typically tough to treat due to the location, which doesn't allow typical tourniquet implementation very quickly or easily. To treat the wound a packing method is usually applied until a pelvic binder or torso tourniquet can be implemented. The pelvic wounds of the present disclosure can include a pressure sensor to measure the pressure of the blood line while the blood is pumping to slow down the bleeding once the packing is done correctly. Additionally, the pelvic wounds can include a force sensor to sense when the correct tourniquet pressure (e.g., via a pelvic binder and/or toros tourniquet) is applied and stop the bleeding. Further, in some aspects, in the case of simulating an arterial bleeding, once the force sensor detects the tourniquet is properly applied the pulses in the leg of the patient simulator may be stopped to indicate that the artery was correctly blocked. In some aspects, if the force sensor detects the tourniquet is not properly applied, then the pulses of the leg may continue, but at a reduced force to indicate that the artery has not been correctly blocked yet. The reduced force of the pulses may be based, at least in part, on the amount of force detected by the force sensor relative to what is expected for the properly applied tourniquet.

In some aspects, a patient simulator comprises: a simulated torso having a recess; and a wound assembly positioned within the recess of the simulated torso, the wound assembly comprising a multi-layered tissue structure with a central cavity in communication with a reservoir of simulated blood, wherein a control unit associated with the wound assembly is configured to control an amount of simulated blood flow through the wound assembly based on at least one of an application of packing material into the central cavity or application of pressure to the wound assembly.

The control unit may be configured to control the amount of simulated blood flow based on the application of pressure to the wound assembly. The wound assembly may include a force sensor configured to monitor the amount of pressure applied to the wound assembly. The control unit may be in communication with the force sensor. The control unit may be further configured to slow and/or stop the simulated blood flow based on the amount of pressure applied to the wound assembly as detected by the force sensor. The control unit may be further configured to control a strength of an arterial pulse of the patient simulator based on the amount of pressure applied to the wound assembly as detected by the force sensor. The control unit is configured to control the amount of simulated blood flow by: slowing the simulated blood flow if the force sensor detects the amount of pressure applied satisfies a first threshold; and stopping the simulated blood flow if the force sensor detects the amount of pressure applied satisfies a second threshold greater than the first threshold.

The control unit may be configured to control the amount of simulated blood flow based on the application of packing material into the central cavity. The wound assembly may include a pressure sensor configured to monitor the application of packing material into the central cavity. The control unit may be in communication with the pressure sensor. The control unit may be configured to slow and/or stop the simulated blood flow based on a pressure sensed by the pressure sensor. The control unit may be configured to control the amount of simulated blood flow by: slowing the simulated blood flow if the pressure sensor senses a pressure satisfying a first threshold; and stopping the simulated blood flow if the pressure sensor detects a pressure satisfying a second threshold greater than the first threshold.

The control unit may be configured to control the amount of simulated blood flow based on both the application of packing material into the central cavity and the application of pressure to the wound assembly. The wound assembly may include: a force sensor configured to monitor the amount of pressure applied to the wound assembly and a pressure sensor configured to monitor the application of packing material into the central cavity. The control unit may be in communication with the force sensor and the pressure sensor. The force sensor may be configured to monitor the amount of pressure applied to the wound assembly by a pelvic binder or a torso tourniquet used on the patient simulator.

In some aspects, a wound assembly for a patient simulator comprises a multi-layered tissue structure sized and shaped for positioning within a recess of the patient simulator, the multi-layered tissue structure including a central cavity configured to be in communication with a reservoir of simulated blood; and a control unit configured to control an amount of simulated blood flow through the wound assembly based on at least one of an application of packing material into the central cavity or application of pressure to the wound assembly. The wound assembly may include a force sensor configured to monitor the amount of pressure applied to the wound assembly. The control unit may be configured to control the amount of simulated blood flow based on the application of pressure to the wound assembly as detected by the force sensor. The control unit may be further configured to control a strength of an arterial pulse of the patient simulator based on the amount of pressure applied to the wound assembly as detected by the force sensor. The wound assembly may include a pressure sensor configured to monitor the application of packing material into the central cavity. The control unit may be configured to control the amount of simulated blood flow based on a pressure sensed by the pressure sensor. The wound assembly may include a force sensor configured to monitor the amount of pressure applied to the wound assembly and a pressure sensor configured to monitor the application of packing material into the central cavity. The control unit may be configured to control the amount of simulated blood flow based on both the application of pressure to the wound assembly as detected by the force sensor and a pressure sensed by the pressure sensor.

Other aspects, features, and embodiments of the present invention will become apparent to those of ordinary skill in the art, upon reviewing the following description of specific, exemplary instances of the present invention in conjunction with the accompanying figures. While features of the present invention may be discussed relative to certain examples and figures below, all aspects of the present invention can include one or more of the advantageous features discussed herein. In other words, while one or more arrangements may be discussed as having certain advantageous features, one or more of such features may also be used in accordance with the various aspects and examples of the invention discussed herein. In similar fashion, while exemplary aspects may be discussed below in the context of a device, a system, or a method, it should be understood that such exemplary aspects can be implemented in various devices, systems, and methods.

### BRIEF DESCRIPTION OF THE DRAWINGS

Other features and advantages of the present disclosure will become apparent in the following detailed description of illustrative embodiments with reference to the accompanying of drawings, of which:

FIG. 1 is a perspective view of a patient simulator including a simulated torso, a simulated head, a simulated neck, a simulated right arm, a simulated left arm, a simulated right leg, and a simulated left leg, including at least one pelvic wound assembly according to one or more aspects of the present disclosure.

FIG. 2 is a perspective, phantom view of a pelvic wound assembly, according to one or more aspects of the present disclosure.

FIG. 3 is a perspective cross-sectional view of the pelvic wound assembly of FIG. 2, according to one or more aspects of the present disclosure.

FIG. 4 is a cross-sectional side view of the pelvic wound assembly of FIGS. 2-3 coupled with a portion of the patient simulator of FIG. 1, according to one or more aspects of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately. For simplicity, in some instances the same reference numbers are used throughout the drawings to refer to the same or like parts.

One of the aims of healthcare simulation is to establish a teaching environment that closely mimics key clinical cases in a reproducible manner. The introduction of high fidelity tetherless simulators, such as those available from Gaumard Scientific Company, Inc., over the past few years has proven to be a significant advance in creating realistic teaching environments. The present disclosure is directed to a patient simulator that expands the functionality of the simulators by increasing the realism of the look, feel, and functionality of the simulators that can be used to train medical personnel in a variety of clinical situations. The patient simulator disclosed herein offers a training platform on which medical scenarios can be performed for the development of medical treatment skills and the advancement of patient safety. Accordingly, the user's medical treatment skills can be obtained and/or improved in a simulated environment without endangering a live patient. Moreover, the patient simulator allows for multiple users to simultaneously work with the patient simulator during a particular medical scenario, thereby facilitating team training and assessment in a realistic, team-based environment.

In several aspects, the patient simulator includes features designed to enhance the educational experience. For example, in several aspects, the system includes a processing module to simulate different medical and/or surgical scenarios during operation of the patient simulator. In several aspects, the system includes a camera system that allows visualization of the procedure for real-time video and log capture for debriefing purposes. In several aspects, the patient simulator is provided with a workbook of medical scenarios that are pre-programmed in an interactive software package, thereby providing a platform on which medical scenarios can be performed for the development of medical treatment skills and general patient safety. Thus, the patient simulators disclosed herein provide a system that is readily expandable and updatable without large expense and that enables users to learn comprehensive medical and surgical skills through “hands-on” training, without sacrificing the experience gained by users in using standard surgical instruments in a simulated patient treatment situation.

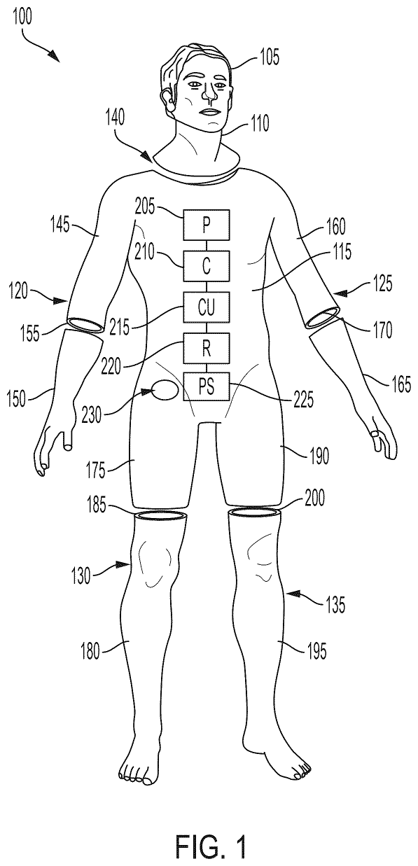

Referring to FIG. 1, in some aspects, a patient simulator is generally referred to by the reference numeral 100 and includes a simulated head 105, a simulated neck 110, a simulated torso 115, a simulated right arm 120 (or “extremity”), a simulated left arm 125 (or “extremity”), a simulated right leg 130 (or “extremity”), and a simulated left leg 135 (or “extremity”). In several embodiments, the patient simulator is, includes, or is part of, a manikin. The simulated head 105 may be coupled to the simulated neck 110. For example, the simulated head 105 may be integrally formed with and/or detachably coupled to the simulated neck 110. The patient simulator 100 may further include a head coupling 140. The simulated neck 110 may be adapted to be detachably coupled to the simulated torso 115 via the head coupling 140. In some aspects, the simulated right arm 120 includes a simulated upper right arm 145 (or “extremity”) and a simulated lower right arm 150 (or “extremity”). The simulated upper right arm 145 may be coupled to the simulated torso 115. For example, the simulated upper right arm 145 may be integrally formed with and/or detachably coupled to the simulated torso 115. The simulated right arm 120 may further include a right arm coupling 155 (or “extremity coupling”). The simulated lower right arm 150 may be detachably coupled to the simulated upper right arm 145 via the right arm coupling 155. Similarly, the simulated left arm 125 may include a simulated upper left arm 160 (or “extremity”) and a simulated lower left arm 165 (or “extremity”). The simulated upper left arm 160 may be coupled to the simulated torso 115. For example, the simulated upper left arm 160 may be integrally formed with and/or detachably coupled to the simulated torso 115. The simulated left arm 125 may further include a left arm coupling 170 (or “extremity coupling”). The simulated lower left arm 165 may be detachably coupled to the simulated upper left arm 160 via the left arm coupling 170.

The simulated right leg 130 may include a simulated upper right leg 175 (or

“extremity”) and a simulated lower right leg 180 (or “extremity”). The simulated upper right leg 175 may be coupled to the simulated torso 115. For example, the simulated upper right leg 175 may be integrally formed with and/or detachably coupled to the simulated torso 115. The simulated right leg 130 may further include a right leg coupling 185 (or “extremity coupling”). The simulated lower right leg 180 may be detachably coupled to the simulated upper right leg 175 via the right leg coupling 185. Similarly, the simulated left leg 135 may include a simulated upper left leg 190 (or “extremity”) and a simulated lower left leg 195 (or “extremity”). The simulated upper left leg 190 may be coupled to the simulated torso 115. For example, the simulated upper left leg 190 may be integrally formed with and/or detachably coupled to the simulated torso 115. The simulated left leg 135 may further include a left leg coupling 200 (or “extremity coupling”). The simulated lower left leg 195 may be detachably coupled to the simulated upper left leg 190 via the left leg coupling 200.

In some instances, the simulated torso 115 may be divided into a simulated upper torso and a simulated lower torso. In such instances, the simulated upper right arm 145 and the simulated upper left arm 160 may be coupled to the simulated upper torso. For example, the simulated upper right arm 145 and the simulated upper left arm 160 may be integrally formed with and/or detachably coupled to the simulated upper torso. The simulated upper right leg 175 and the simulated upper left leg 190 may be coupled to the simulated lower torso. For example, the simulated upper right leg 175 and the simulated upper left leg 190 may be integrally formed with and/or detachably coupled to the simulated lower torso. The simulated torso 115 may further includes a torso coupling via which the simulated upper torso may be detachably coupled to the simulated lower torso.

The simulated torso 115 (as well as the simulated head 105, simulated neck 110, simulated right arm 120, simulated left arm 125, a simulated right leg 130, and/or simulated left leg 135) may contain one or more pump(s) 205, compressor(s) 210, control unit(s) 215, reservoir(s) 220, power source(s) 225, pelvic wound assembl(ies) 230, and/or other components. The pump(s) 205 may be adapted to supply hydraulic pressure to various features/components of the patient simulator 100. The features/components to which hydraulic pressure is supplied by the pump(s) 205 may be contained in the simulated torso 115, the simulated head 105, the simulated right arm 120, the simulated left arm 125, the simulated right leg 130, and/or the simulated left leg 135. In some instances, the pump(s) 205 may supply hydraulic pressure to one or more of the reservoir(s) 220. For example, the pump(s) 205 may cause fluid to be transferred into and/or out of one or more of the reservoir(s) 220. In this regard, the reservoir(s) 220 may contain fluid and/or gas.

The compressor(s) 210 may be adapted to supply pneumatic pressure to various features/components of the patient simulator 100. The features/components to which pneumatic pressure is supplied by the compressor(s) 210 may be contained in the simulated torso 115, the simulated head 105, the simulated right arm 120, the simulated left arm 125, the simulated right leg 130, and/or the simulated left leg 135. In some instances, the compressor(s) 210 may include a scroll compressor. In some instances, the compressor(s) 210 may supply pneumatic pressure to one or more of the reservoir(s) 220. In this regard, the reservoir(s) 220 may contain fluid and/or gas. In some instances, one or more pelvic wound assemblies 230 may be associated with one or more of the pump(s) 205, compressor(s) 210, and/or reservoir(s) 220 to control the flow of fluid and/or gas into and/or through the pelvic wound assemblies 230 for one or more simulation scenarios.

The control unit(s) 215 may be adapted to control the pump(s) 205, the compressor(s) 210, the reservoir(s) 220, including one or more valves associated with the pump(s), compressor(s), and/or reservoir(s), and/or various other features/components of the patient simulator 100. The features/components controlled by the control unit(s) 215 may be contained in the simulated torso 115, the simulated head 105, the simulated right arm 120, the simulated left arm 125, the simulated right leg 130, and/or the simulated left leg 135. In some instances, each of the control unit(s) 215 may be associated with one or more functions and/or features of the patient simulator 100.

The reservoir(s) 220 may contain fluid and/or gas for use in simulating one or more scenarios, functions, and/or features. For example, the reservoir(s) 220 may contain simulated bodily fluids (e.g., blood, urine, saliva, tears, etc.) and/or simulated bodily gasses (e.g., air, O₂, CO₂, etc.). The reservoir(s) 220 may include a single compartment or multiple compartments. The reservoir(s) 220 may be associated with one or more valves to control the flow of fluid and/or gas into and/or out of the reservoir(s) 220 (e.g., to and/or through the pelvic wound assemblies 230).

The power source(s) 225 may supply electrical power to the pump(s) 205, the compressor(s) 210, the control unit(s) 215, the reservoir(s) 220, including one or more valves associated with the pump(s), compressor(s), and/or reservoir(s), the pelvic wound assembl(ies) 230, and various other features/components of the patient simulator 100. The features/components to which electrical power is supplied by the power source(s) 225 may be contained in the simulated torso 115, the simulated head 105, the simulated right arm 120, the simulated left arm 125, the simulated right leg 130, and/or the simulated left leg 135. The features/components to which electrical power is supplied by the power source(s) 225 may be contained in a different portion of the patient simulator 100 than the power source(s) 225. In some aspects, the power source(s) 225 includes lithium battery technology that reduces weight, volume, and complexity while providing greater power density. However, any suitable battery technology may be used in accordance with the present disclosure, including without limitation lithium, lithium-ion, lithium-sulfur, lithium manganese oxide, lithium polymer, lithium titanate, lithium cobalt oxide, lithium iron phosphate, nickel metal hydride, nickel-cadmium, alkaline, supercapacitor, sodium-ion, magnesium, etc.

In some instances, the power source(s) 225 may be positioned within one or more extremities (e.g., the simulated right arm 120, the simulated left arm 125, the simulated right leg 130, and/or the simulated left leg 135) of the patient simulator 100. In this regard, an extremity containing the power source(s) 225 may be detachably coupled to the simulated torso 115. In some aspects, the extremity containing the power source(s) 225 may include a quick-connect connector to facilitate simple and/or fast power system changes (e.g., by swapping an extremity with a depleted power source for an extremity with a charged power source). In this regard, the quick-connect connector may physically couple the extremity to the simulated torso 115 and/or another aspect of the patient simulator 100 (e.g., upper and/or lower arm, upper and/or lower leg, etc.). The quick-connect connector may also electrically couple the power source(s) 225 contained in the extremity to one or more components of the patient simulator 100 (e.g., the pump(s) 205, the compressor(s) 210, the control unit(s) 215, the reservoir(s) 220, including one or more valves associated with the pump(s), compressor(s), and/or reservoir(s), and various other features/components). In some aspects, the quick-connect connector may also pneumatically and/or fluidly couple one or more components (e.g., pump(s) 205, compressor(s) 210, reservoir(s) 220, valve(s), and other pneumatic and/or fluid components) contained in the extremity (along with the power source(s) 225) to one or more other components of the patient simulator 100 (e.g., the pump(s) 205, the compressor(s) 210, the reservoir(s) 220, valve(s), and various other features/components).

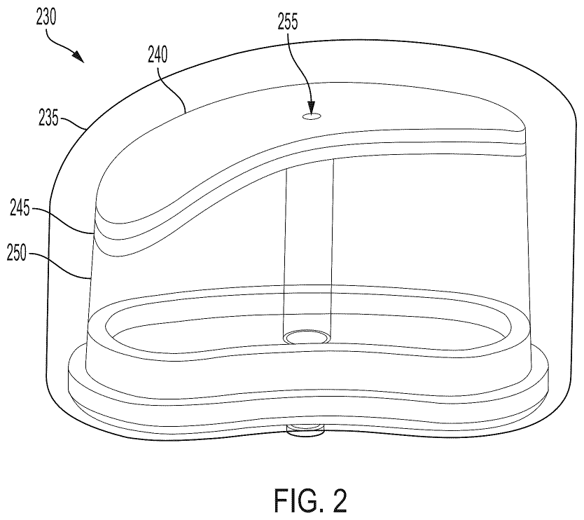

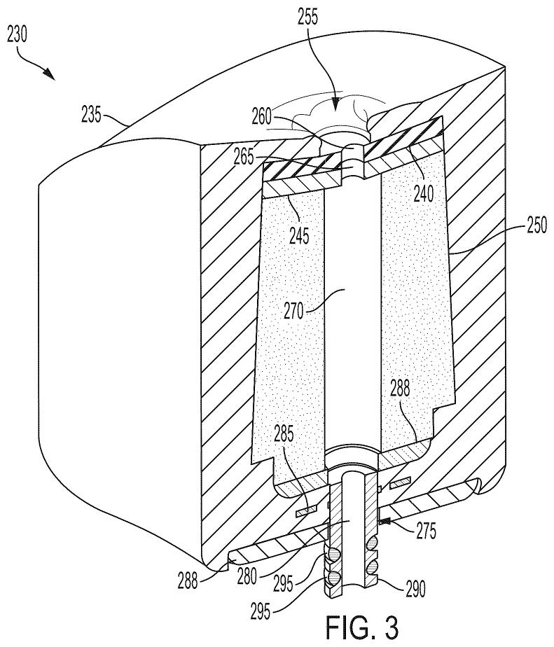

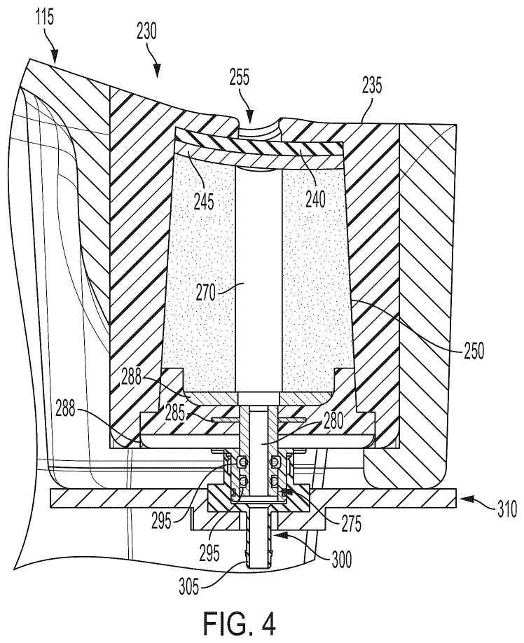

Referring to FIGS. 2-4 and continuing reference to FIG. 1, the patient simulator 100 includes one or more pelvic wound assemblies 230. For example, FIG. 2 is a phantom perspective view of a pelvic wound assembly 230 showing some of the internal layers and/or components, according to one or more aspects of the present disclosure. FIG. 3 is a perspective cross-sectional view of the pelvic wound assembly 230 of FIG. 2, according to one or more aspects of the present disclosure. FIG. 4 is a cross-sectional side view of the pelvic wound assembly 230 of FIGS. 2-3 coupled with a portion of the patient simulator 100 of FIG. 1, according to one or more aspects of the present disclosure.

As shown in FIGS. 2-4, the pelvic wound assembly 230 includes a multi-layered construction with a central cavity to simulate a gunshot wound or other similar injury in the pelvic region or other part of the torso 115 of the patient simulator. In this regard, the pelvic wound assembly 230 is particularly well-suited to simulate injuries (and associated treatments) that occur in parts of the body not amenable to use of a typical tourniquet (e.g., as used on an arm or leg). As will be discussed, the pelvic wound assembly 230 is configured to control the amount of blood flow from the simulated wound based on the application of packing material into the wound and/or application of a pelvic binder or torso tourniquet to simulate treatment of a similar type of natural wound.

The pelvic wound assembly 230 may be sized and shaped to fit into a corresponding recess or opening in the patient simulator 100. In some instances, the recess or opening is within the torso of the patient simulator 100 and, in some particular instances, in the pelvic and/or hip area of the patient simulator. As shown in FIGS. 2-4, the pelvic wound assembly 230 includes an outer skin layer 235, a tissue layer 240, a muscle layer 245, and a foam layer 250. In some aspects, the outer skin layer 235, the tissue layer 240, and/or the muscle layer 245 may similar to or the same as similar layers described in U.S. Pat. Nos. 11,756,451, 8,696,362, 8,016,598, 7,976,312, 7,976,313, U.S. patent application Ser. No. 11/952,669 (Publication No. 20090148822), U.S. Pat. Nos. 7,114,954, 6,758,676, 6,503,087, 6,527,558, 6,443,735, 6,193,519, and 5,853,292, each herein incorporated by reference in its entirety.

The pelvic wound assembly 230 includes a central opening 255 that extends through each of the outer skin layer 235, the tissue layer 240, the muscle layer 245, and the foam layer 250. For example, the tissue layer 240 includes an opening 260 and the muscle layer 245 includes an opening 265. Similarly, the foam layer 250 includes an opening 270. The openings 260, 265, and 270 and associated layers 240, 245, and 250, respectively, allow separation between the muscle layer 245 and the foam layer 250 to simulate the “peeling of skin” and facilitate the use of gauze packing and plugging for simulated treatment of the wound. In this regard, the outer skin layer 235 may include a silicone gunshot injury design exterior (or other applicable exterior injury design). For example, the outer skin layer 235 may include discolorations, tears, marks, and/or other features to simulate a realistic gunshot or other puncture wound. The tissue layer 240 may be a silicone adipose tissue layer in some instances. The muscle layer 245 may be a silicone muscle layer. The foam layer 250 may be a foam filler (silicon foam or otherwise) for packing resistance and blood flow guidance into and through the simulated wound. In some instances, the wound simulates an arterial wound and blood flow pulses through the wound in synchronization with the pulse of the patient simulator 100. In this regard, the foam layer 250 may be coupled to a hydraulic port bushing 275 that includes an opening 280 to facilitate passage of blood from a reservoir 220 of the patient simulator 100 into the wound. In some instances, a flange 285 of the hydraulic port bushing 275 may be silicone embedded during injection and/or sandwiched between two layers of plastic 288 or other supporting material for connection support (see, e.g., FIGS. 3 and 4). The hydraulic port bushing 275 may include a distal end 290 with one or more O-rings 295 or other connection members to facilitate fluid connection of pelvic wound assembly 230 to one or more reservoirs 220 of the patient simulator containing simulated blood or other fluid/gas. For example, as shown in FIG. 4, the hydraulic port bushing 275 may mate with hydraulic connector 300 of the patient simulator 100. In some instances, the hydraulic connector 300 is positioned within the opening or recess of the patient simulator that receives the pelvic wound assembly 230. The hydraulic connector 300 may include a port 305 that is configured to. In some aspects, the hydraulic connector 300 is secured to a mounting plate 310 or other structural component of the patient simulator 100 that is configured to maintain the position of the hydraulic connector 300 and/or the pelvic wound assembly 230 (once inserted into the patient simulator 100 and/or coupled to the hydraulic connector).

In some aspects, the pelvic wound assembly 230 includes a pressure sensor to measure the pressure of the blood line (e.g., within the hydraulic connector 300, hydraulic port bushing 275, and/or within the opening 255 (e.g., within the opening 270 of the foam layer 250)). In this regard, as packing is properly applied to the pelvic wound, the pressure sensed by the pressure sensor will increase and the patient simulator can slow down the amount of blood being pumped to the pelvic wound. In some aspects, the amount or volume of blood pumped from a reservoir 220 to the pelvic wound assembly 230 by a pump 205 of the patient simulator is based, at least in part, on the pressure measurement(s) obtained by the pressure sensor associated with the pelvic wound assembly 230.

Additionally, the pelvic wound assembly 230 can include a force sensor to sense when the correct tourniquet pressure (e.g., via a pelvic binder and/or toros tourniquet) is applied. In some aspects, a force sensor is coupled to and/or integrated into the mounting plate 310 and/or the hydraulic connector 300. In this regard, the force sensor may be configured to monitor an amount of force applied to the pelvic wound assembly 230. For example, the force sensor may be configured to monitor the amount of force applied to the pelvic wound assembly 230 by a pelvic binder or torso tourniquet. In response to the force sensor detecting that the appropriate force has been applied, the patient simulator 100 may stop the bleeding of the pelvic wound assembly 230 entirely (e.g., by stopping the associated pump 205 and/or closing one or more valves associated with the pump 205, the reservoir 220, and/or the pelvic wound assembly 230). In some aspects, in the case of simulating an arterial bleeding, once the force sensor detects the tourniquet is properly applied the pulses in the leg of the patient simulator may be stopped to indicate that the artery associated with the pelvic wound was correctly blocked. In some aspects, if the force sensor detects the tourniquet is not properly applied, then the pulses of the leg may continue, but at a reduced force to indicate that the artery has not been correctly blocked yet. The reduced force of the pulses may be based, at least in part, on the amount of force detected by the force sensor relative to what is expected for the properly applied tourniquet.

Although illustrative embodiments have been shown and described, a wide range of modification, change, and substitution is contemplated in the foregoing disclosure and in some instances, some features of the present disclosure may be employed without a corresponding use of the other features. It is understood that such variations may be made in the foregoing without departing from the scope of the embodiment. Accordingly, it is appropriate that the appended claims be construed broadly and in a manner consistent with the scope of the present disclosure.

1. A patient simulator, comprising:
a simulated torso having a recess; and
a wound assembly positioned within the recess of the simulated torso, the wound assembly comprising a multi-layered tissue structure with a central cavity in communication with a reservoir of simulated blood, wherein a control unit associated with the wound assembly is configured to control an amount of simulated blood flow through the wound assembly based on at least one of an application of packing material into the central cavity or application of pressure to the wound assembly.

2. The patient simulator of claim 1, wherein the control unit is configured to control the amount of simulated blood flow based on the application of pressure to the wound assembly.

3. The patient simulator of claim 2, wherein the wound assembly includes a force sensor configured to monitor the amount of pressure applied to the wound assembly, wherein the control unit is in communication with the force sensor.

4. The patient simulator of claim 3, wherein the control unit is further configured to slow and/or stop the simulated blood flow based on the amount of pressure applied to the wound assembly as detected by the force sensor.

5. The patient simulator of claim 4, wherein the control unit is further configured to control a strength of an arterial pulse of the patient simulator based on the amount of pressure applied to the wound assembly as detected by the force sensor.

6. The patient simulator of claim 3, wherein the control unit is configured to control the amount of simulated blood flow by:
slowing the simulated blood flow if the force sensor detects the amount of pressure applied satisfies a first threshold; and
stopping the simulated blood flow if the force sensor detects the amount of pressure applied satisfies a second threshold greater than the first threshold.

7. The patient simulator of claim 1, wherein the control unit is configured to control the amount of simulated blood flow based on the application of packing material into the central cavity.

8. The patient simulator of claim 7, wherein the wound assembly includes a pressure sensor configured to monitor the application of packing material into the central cavity, wherein the control unit is in communication with the pressure sensor.

9. The patient simulator of claim 8, wherein the control unit is configured to slow and/or stop the simulated blood flow based on a pressure sensed by the pressure sensor.

10. The patient simulator of claim 8, wherein the control unit is configured to control the amount of simulated blood flow by:
slowing the simulated blood flow if the pressure sensor senses a pressure satisfying a first threshold; and
stopping the simulated blood flow if the pressure sensor detects a pressure satisfying a second threshold greater than the first threshold.

11. The patient simulator of claim 1, wherein the control unit is configured to control the amount of simulated blood flow based on both the application of packing material into the central cavity and the application of pressure to the wound assembly.

12. The patient simulator of claim 11, wherein the wound assembly includes:
a force sensor configured to monitor the amount of pressure applied to the wound assembly; and
a pressure sensor configured to monitor the application of packing material into the central cavity;
wherein the control unit is in communication with the force sensor and the pressure sensor.

13. The patient simulator of claim 12, wherein the force sensor is configured to monitor the amount of pressure applied to the wound assembly by a pelvic binder or a torso tourniquet used on the patient simulator.

14. A wound assembly for a patient simulator, the wound assembly comprising:
a multi-layered tissue structure sized and shaped for positioning within a recess of the patient simulator, the multi-layered tissue structure including a central cavity configured to be in communication with a reservoir of simulated blood; and
a control unit configured to control an amount of simulated blood flow through the wound assembly based on at least one of an application of packing material into the central cavity or application of pressure to the wound assembly.

15. The wound assembly of claim 14, wherein:
the wound assembly includes a force sensor configured to monitor the amount of pressure applied to the wound assembly; and
the control unit is configured to control the amount of simulated blood flow based on the application of pressure to the wound assembly as detected by the force sensor.

16. The wound assembly of claim 15, wherein the control unit is further configured to control a strength of an arterial pulse of the patient simulator based on the amount of pressure applied to the wound assembly as detected by the force sensor.

17. The wound assembly of claim 14, wherein:
the wound assembly includes a pressure sensor configured to monitor the application of packing material into the central cavity; and
the control unit is configured to control the amount of simulated blood flow based on a pressure sensed by the pressure sensor.

18. The wound assembly of claim 14, wherein:
the wound assembly includes a force sensor configured to monitor the amount of pressure applied to the wound assembly;
the wound assembly includes a pressure sensor configured to monitor the application of packing material into the central cavity; and
the control unit is configured to control the amount of simulated blood flow based on both the application of pressure to the wound assembly as detected by the force sensor and a pressure sensed by the pressure sensor.
